(19) United States
(12) Patent Application Publication
(10) Pub. No.: US 2018/0265324 A1
(43) Pub. Date: Sep. 20, 2018

(54) SIGNATURE FORMING METHOD AND SHEET FOLDING MACHINE

(71) Applicant: Horizon International Inc., Shiga (JP)

(72) Inventors: Hiroki YAMAMOTO, Shiga (JP); Yoshikazu NAKAMURA, Shiga (JP); Yuya SUGAI, Shiga (JP)

(21) Appl. No.: 15/761,129

(22) PCT Filed: Sep. 29, 2015
(86) PCT No.: PCT/JP2015/077527

§ 371 Date: Mar. 19, 2018

(51) Int. Cl. B65H 45/28; B26D 1/22; B26D 3/08

(52) U.S. Cl. CPC B65H 45/28; B26D 3/08; B26D 1/22

(57) ABSTRACT

While conveying paper, the paper is folded in a first folding pattern at right angles to the conveyance direction. By bending and rupturing the folded paper, one or multiple perforation lines corresponding to a second folding pattern that is at right angles to the fold(s) are formed in the paper. While conveying the paper with perforations in a direction at right angles to the previous conveyance direction, the paper is folded in the second folding pattern along the perforations, thereby forming a quire.

### TECHNICAL FIELD

The present invention relates to a method of forming signatures including steps of folding a sheet at a right angle to a travelling direction of the sheet in a predetermined first fold pattern while conveying the sheet in a first direction, and further folding the folded sheet at a right angle to the fold in a predetermined second fold pattern while conveying the folded sheet in a direction perpendicular to the first direction, and a sheet folding machine suitable to carry out the method.

### BACKGROUND ART

As a sheet folding machine for forming signatures, for example, a sheet folding machine which is composed of a first buckle-type sheet folding machines and a second buckle-type sheet folding machine connected at a right angle to the first buckle-type sheet folding machine is well known to one skilled in the art.

In this sheet folding machine, a sheet is folded at a right angle to a travelling direction thereof according to a first fold pattern (only mountain fold(s) or only valley fold(s) or a combination of mountain and valley folds) by the first buckle-type sheet folding machine and thereafter, further folded at a right angle to the fold thereof according to a second fold pattern by the second buckle-type sheet folding machine.

In this case, a sheet folded by the first buckle-type sheet folding machine increases thickness and stiffness thereof compared to an unfolded sheet, whereby when the folded sheet discharged from the first buckle-type sheet folding machine is fed directly to the second buckle-type sheet folding machine, problems of a bulging fold and position gap of a fold etc. can be encountered.

Therefore, in the prior art, one or more lines of perforations, which correspond to a fold pattern to be formed by the second buckle-type sheet folding machine, are formed on the sheet folded by the first buckle-type sheet folding machine and thereafter, the folded sheet is further folded along the line(s) of perforations by the second buckle-type sheet folding machine. Signatures formed in this way have a proper and good-looking folds, and can be strongly adhered to each other through such folds.

A conventional perforating unit is disclosed in, for example, Patent Documents 1 and 2. The perforating unit disclosed in Patent Documents 1 and 2 comprises upper and lower shafts arranged one above the other in a manner such that these shafts face each other across a conveying path of a sheet. The upper and lower shafts extend parallel with each other and orthogonally across the conveying path, and supported so as to be rotatable around axes thereof.

One of the upper and lower shafts has one or more circular perforating blades mounted thereon to rotate with the one of the shafts. The other of the upper and lower shafts has one or more circular receiving blades mounted thereon to rotate with the other of the shafts at a position or positions corresponding to the perforating blade(s).

AS shown in FIG. 5A, the upper and lower shafts 30, 31 are rotated in a direction of conveying the sheet while the paired perforating blade 32 and receiving blade 33 contacting with each other. Then one or more lines of perforations are formed on the sheet while the sheet being conveyed between the rotating perforating blade(s) 32 and receiving blade(s) 33.

A perforating unit shown in FIG. 5B is known in the prior art. In the perforating unit shown in FIG. 5B, the lower shaft having the one or more receiving blade is replaced with a blade receiving roller 34 extending along the upper shaft 30. According to this perforating unit, the upper shaft 30 and blade receiving roller 34 are rotated while one or more circular perforating blades 32′ of the upper shaft 34 and the blade receiving roller 34 contacting with each other. Then one or more lines of perforations are formed on the sheet while the sheet being conveyed between the rotating perforating blade(s) 32′ and blade receiving roller 34.

In these conventional perforating units, as shown in FIG. 5C, the formation of the line of perforations is achieved by shearing the sheet P′ by means of the perforating blade 32 and receiving blade 33 (or the perforating blade 32′ and blade receiving roller 34). In this case, because edges of the perforations 35 formed by the shearing cannot control directions of folding, the sheet P′ can be smoothly both mountain folded and valley folded along the line(s) of perforation.

On the other hand, when the sheet P′ is further folded along the line(s) of perforations by the second buckle-type sheet folding machine, the sheet P′ is sometimes valley folded on its side to be mountain folded and mountain folded on its side to be valley folded due to uncontrollability of fold directions of the edges of the perforations 35. As a result, as shown in FIG. 6C, a part of a fold f of a signature P′ is reversely folded to form a sunk corner 36.

A problem of the sunk corner can be regularly resolved by adjusting stoppers arranged buckles of the second buckle-type sheet folding machine or adjusting positions of sheet inlets of the buckles.

However, when a large variety of signatures are produced in small lots, taking the manufacturing cost and production efficiency into account, it should not be allowed to remove the related signature and adjust the buckle-type sheet folding machine every time the sunk corner is caused.

### PRIOR ART DOCUMENTS

### Patent Documents

Patent Document 1: JP 2005-81483 A

Patent Document 2: JP 2005-81512 A

### SUMMARY OF THE INVENTION

### Problems to be Solved by the Invention

It is, therefore the object of the present invention to provide a sheet folding machine capable of forming a signature with perforations without causing sunk corners.

### Means for Solving the Problems

In order to achieve the object, a first invention provides a method of forming a signature including steps of (1) folding a sheet at a right angle to a travelling direction of the sheet in a predetermined first fold pattern while conveying the sheet in a first direction; (2) forming one or more lines of perforations according to a predetermined second fold pattern on the folded sheet at a right angle to the fold(s) of the folded sheet; and (3) further folding the folded sheet along the one or more lines of perforations to form a signature while conveying the folded sheet in a second direction perpendicular to the first direction, characterized in that the formation of the one or more lines of perforations in the step (2) is performed by bending and fracturing the folded sheet at a right angle to the fold(s) of the folded sheet.

According to a preferred embodiment of the first invention, the bending fracture is caused by passing the folded sheet through a gap between at least one pair of a circular perforating blade and a receiving roller while conveying the folded sheet in the second direction, the paired circular perforating blade and receiving roller being arranged opposite to each other with a gap therebetween and rotating around an axis parallel with the first direction, respectively, wherein the at least one pair of circular perforating blade and receiving roller is arranged in the first direction according to the second fold pattern, wherein a plurality of double edges are attached to a circumference of the circular perforating blade at even intervals, and a circular groove is formed on the receiving roller and opposed to the plural double edges of the associated circular perforating blade, a width of the circular groove being larger than a thickness of each double edges, wherein the plural double edges of the circular perforating blade enter the associated circular groove of the receiving roller in such a manner that a tip of each double edges is spaced a certain distance from a bottom of the circular groove.

In order to achieve the object, a second invention provides a sheet folding machine having a first folding unit; a second folding unit arranged downstream of and at a right angle to the first folding unit; and a perforating unit arranged between the first and second folding units, wherein while a sheet is conveyed through the first folding unit, the perforating unit and the second folding unit, the sheet is folded at a right angle to the travelling direction thereof in a predetermined first fold pattern by the first folding unit, one or more lines of perforations are formed on the folded sheet by the perforating unit, the one or more lines of perforations being extended at a right angle to the fold(s) of the folded sheet according to a predetermined second fold pattern, and the folded sheet is further folded along the one or more lines of perforations by the second folding unit, characterized in that the perforating unit comprises: first and second shafts; a motor for rotating the first shaft; and a drive mechanism arranged between the first and second shafts to rotate the second shaft synchronously with the first shaft, wherein one or more pairs of circular perforating blades and receiving rollers are mounted on the first and second shaft in such a manner that the paired circular perforating blade and receiving rollers are arranged opposite to each other, wherein the circular perforating blade is provided with a plurality of double edges on a circumference thereof, the plural double edges being equally spaced, and the receiving roller is provided with a circular groove opposed to the plural double edges of the associated circular perforating blade, a width of the circular groove being larger than a thickness of each double edges, wherein the plural double edges of the circular perforating blade enter the associated circular groove of the receiving roller in such a manner that a tip of each double edges is spaced a certain distance from a bottom of the circular groove, wherein the one or more lines of perforations are formed by bending fracture of the folded sheet, the bending fracture being caused by the folded sheet folded by the first folding unit being conveyed through a gap between the pair of circular perforating blade and receiving roller.

According to a preferred embodiment of the second invention, the circular groove of the receiving roller has a rectangular cross-section. According to another preferred embodiment of the second invention, a plurality of first feed rollers are mounted on the first shaft so as to be rotated with the first shaft, and a plurality of second feed rollers which correspond to the first rollers, respectively are mounted on the second shaft so as to be rotated with the second shaft, and the paired first and second rollers contact with each other to constitute a feed roller pair.

### Effect of the Invention

According to the present invention, after a sheet is folded in the first fold pattern, the one or more lines of perforations are formed on the folded sheet by bending and fracturing the folded sheet at a right angle to the fold(s) of the folded sheet. Edges of the perforations formed by the bending fracture stand from one side of the sheet in a direction of pushing of the circular perforating blade.

The standing edges of the perforations define a direction of folding of the sheet. That is to say, a side of the sheet on which the standing edges are positioned is smoothly mountain folded, but difficult to be valley folded because the standing edges function as stoppers.

Furthermore, according to the present invention, the one or more lines of perforations correspond to the second fold pattern to be formed in a subsequent folding process. Thus the line(s) of perforations is(are) formed in such a manner that the standing edges are positioned on a side of a sheet to be mountain folded in the second fold pattern while the standing edges are not on a side of the sheet to be valley folded. Then in the subsequent folding process, the sheet is folded along the line(s) of perforations in the second fold pattern, so that the occurrence of the sunk corner is prevented surely.

### BRIEF DESCRIPTION OF THE DRAWINGS

FIG. 1 is a flow chart of a signature forming method according to an embodiment of the present invention.

FIG. 2 is a plan view schematically illustrating a configuration of a sheet folding machine according to an embodiment of the present invention.

FIG. 3A is a perspective view of a perforating unit of the sheet folding machine shown in FIG. 2.

FIG. 3B is a plan view of a circular perforating blade of the perforating unit shown in FIG. 3A.

FIG. 4A is an enlarged front view of a major part of the perforating unit shown in FIG. 3.

FIG. 4B is a partially enlarged view illustrating a situation in which the perforating unit shown in FIG. 3 performs the bending fracture of a sheet.

FIGS. 5A and 5B are views similar to FIG. 4A illustrating major parts of conventional perforating units.

FIG. 5C is a view similar to FIG. 4B illustrating a situation in which the perforating unit shown in FIG. 5A performs the shearing of a sheet.

FIG. 6A is a perspective view of a signature formed by the signature forming method according to the present invention.

FIG. 6B is an enlarged perspective view of a corner of the signature shown in FIG. 6A.

FIG. 6C is an enlarged perspective view of a corner of a signature formed by conventional signature forming method.

### BEST MODE FOR CARRYING OUT THE INVENTION

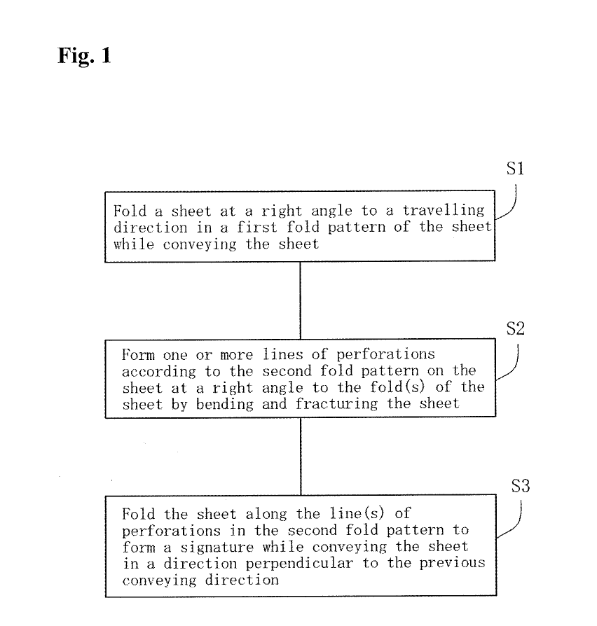

A preferred embodiment of the present invention will be explained below with reference to accompanying drawings. FIG. 1 is a flow chart of a signature forming method according to an embodiment of the present invention. Referring to FIG. 1, according to the present invention, a sheet is initially folded at a right angle to a travelling direction of the sheet in a predetermined first fold pattern while being conveyed in a first direction (FIG. 1, Step S1). In this case, the first fold pattern is comprised of only mountain fold(s) or only valley fold(s) or a combination of mountain and valley folds.

Next, one or more lines of perforations according to a predetermined second fold pattern is formed on the folded sheet at a right angle to the fold(s) of the folded sheet by bending and fracturing the folded sheet (FIG. 1, Step S2). The bending fracture is caused by passing the folded sheet through a gap between at least one pair of a circular perforating blade and a receiving roller while conveying the folded sheet in a second direction perpendicular to the first direction. The paired circular perforating blade and receiving roller are arranged opposite to each other with a gap therebetween and rotates around an axis parallel with the first direction, respectively.

In this case, the pair of circular perforating blade and receiving roller is arranged in the first direction according to the second fold pattern. That is to say, the circular perforating blade and receiving roller are arranged at each folding position of the second fold pattern in a manner such that the circular perforating blade is opposed to a side of a sheet to be valley folded, while the receiving roller is opposed to a side of the sheet to be mountain folded.

The circular perforating blade is composed of a circular blade body and a plurality of double edges attached to a circumference of the circular blade body at even intervals. Also, a circular groove is formed on the receiving roller to be opposed to the plural double edges of the associated circular perforating blade. A width of the circular groove is larger than a thickness of each double edges. The plural double edges of the circular perforating blade enter the associated circular groove of the receiving roller in such a manner that a tip of each double edges is spaced a certain distance from a bottom of the circular groove.

Then the folded sheet is further folded along the line(s) of perforations to form a signature while the folded sheet being conveyed in the second direction perpendicular to the first direction (FIG. 1, Step S3).

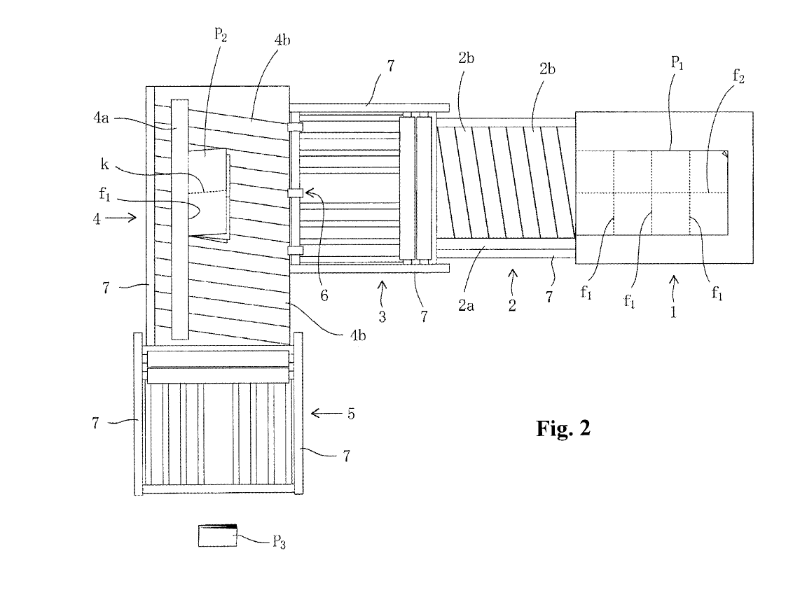

FIG. 2 is a plan view schematically illustrating a configuration of a sheet folding machine suitable to carry out the signature forming method of the present invention. Referring to FIG. 2, the sheet folding machine of the present invention comprises a sheet feed unit 1 supplying sheets P1 one by one and a first conveying unit 2 arranged downstream of the sheet feed unit 1 to convey P1 supplied from the sheet feed unit 1.

The first conveying unit 2 has an alignment member 2a extending in a direction of conveying the sheet P1 (a first direction), a plurality of idle rollers 2b arranged at an angle to the alignment member 2a and extending parallel with each other, and a suction conveyer (not shown) arranged underside of the idle rollers 2b and extending in the first direction. The sheet P1 is conveyed on the idle rollers 2b while an attitude thereof being controlled by the alignment member 2a.

The sheet folding machine also comprises a first sheet folding unit 3 arranged downstream of the first conveying unit 2 to fold the sheet P1 at a right angle to the travelling direction of the sheet P1 (the first direction). In this embodiment, the first sheet folding unit 3 is a buckle-type sheet folding unit.

A second conveying unit 4 is arranged downstream of and at a right angle to the first sheet folding unit 3 to convey the sheet P2 in a second direction perpendicular to the first direction. Like the first conveying unit 2, the second conveying unit 4 has an alignment member 4a extending in the second direction, a plurality of idle rollers 4b arranged at an angle to the alignment member 2a and extending parallel with each other, and a suction conveyer (not shown) arranged underside of the idle rollers 2b and extending in the second direction. The sheet P2 folded by the first sheet folding unit 3 is conveyed on the idle rollers 4b while an attitude thereof being controlled by the alignment member 4a.

A second sheet folding unit 5 is arranged downstream of the second conveying unit 4 to further fold the folded sheet P2 at a right angle to the fold(s)of the sheet P2. In this embodiment, the second sheet folding unit 5 is a buckle-type sheet folding unit. The sheet folding machine further has a perforating unit 6 arranged at an exit of the first sheet folding unit 3.

Thus the sheet P1 supplied from the sheet feed unit 1 is folded at a right angle to the travelling direction thereof in a predetermined fold pattern by the first sheet folding unit 3 (in this embodiment, the sheet P1 is folded in half and further folded in half), perforated at a right angle to the folds f1 thereof according to a predetermined second fold pattern (in this embodiment, the sheet P2 is folded in half), and thereafter further folded along a line of perforations k according to the second fold pattern by the second sheet folding unit 5 (a fold f2), while being conveyed through the first sheet folding unit 3, the perforating unit 6 and the second sheet folding unit 5.

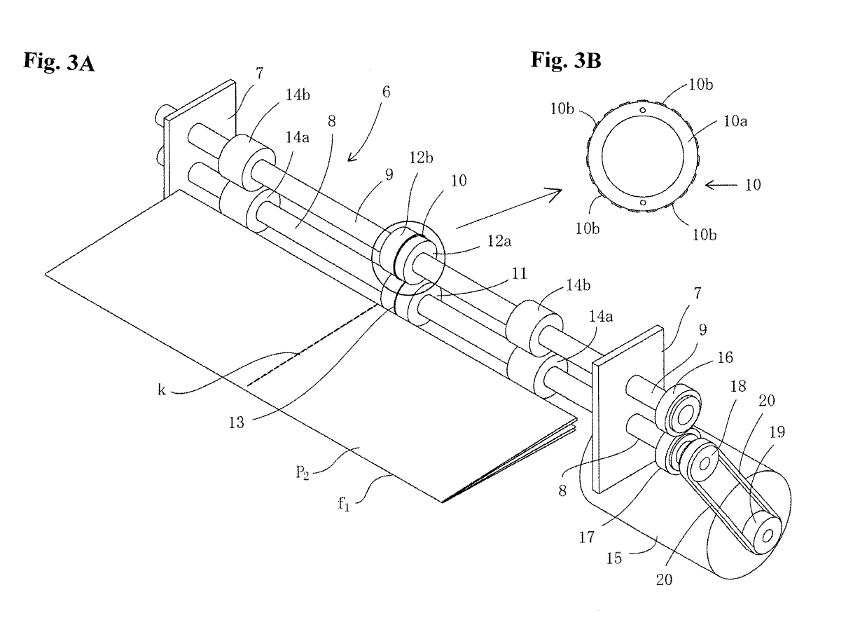

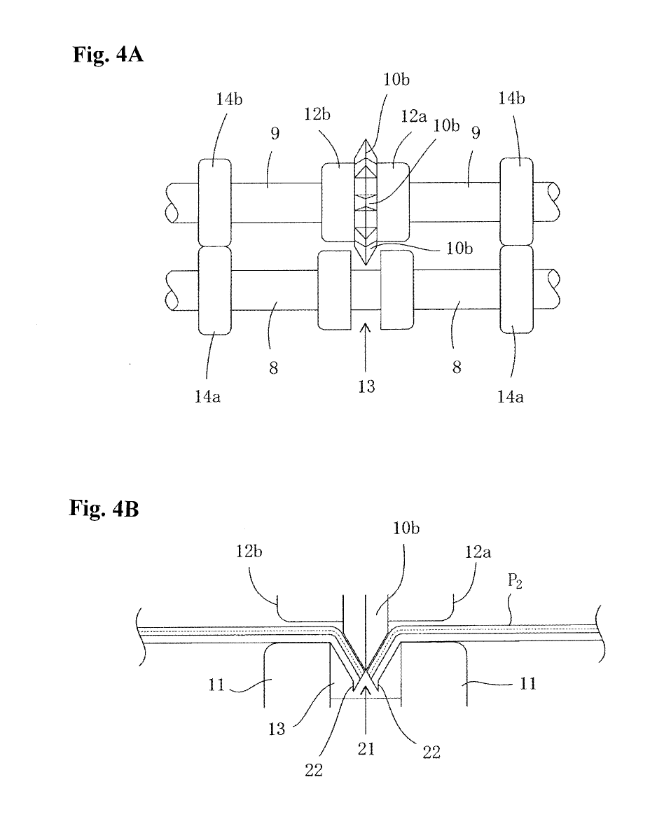

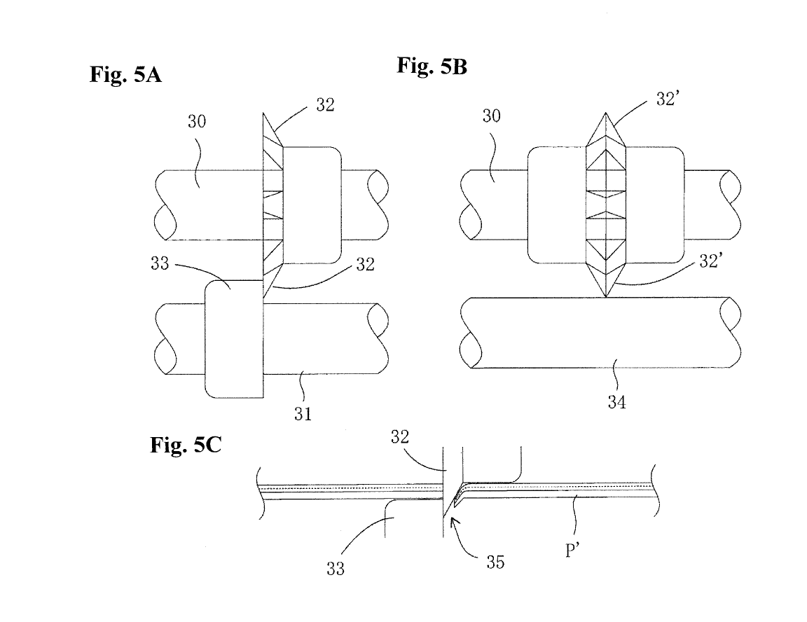

FIG. 3A is a perspective view of a perforating unit of the sheet folding machine shown in FIG. 2, and FIG. 3B is a plan view of a circular perforating blade of the perforating unit shown in FIG. 3A. FIG. 4A is an enlarged front view of a major part of the perforating unit shown in FIG. 3, and FIG. 4B is a partially enlarged view illustrating a situation in which the perforating unit shown in FIG. 3 performs the bending fracture of a sheet. Referring to FIG. 3, the perforating unit 6 comprises first and second shafts 8, 9 facing each other across a conveying path of the sheet P2, extending orthogonally across the conveying path and parallel with each other, and supported by a frame 7 to rotate around axes thereof.

A drive roller 17 is mounted on one end of the first shaft 8 to rotate around an axis thereof together with the first shaft. A drive roller 16 is mounted on one end of the second shaft 9 to rotate around an axis thereof together with the second shaft 9. The rollers 16 and 17 are pressed against each other.

The perforating unit 6 further comprises a motor 15 attached to the frame 7 under the drive roller 17. A drive shaft of the motor 15 is extended parallel with the first and second shafts 8, 9 and provided with a pulley 19. On the other hand, a pulley 18 is mounted on the one end of the first shaft 8, and a drive belt 20 is extended between the pulleys 18 and 19. Thus the second shaft 9 is rotated synchronously with the first shaft 8 in the direction of conveying the sheet P2 (the first direction) by the motor 15.

A circular perforating blade 10 is mounted on the second shaft 9 to rotate with the second shaft 9, and a receiving roller 11 is mounted on a portion of the first shaft 8 facing to the circular perforating blade 10 in such a manner that the receiving roller 11 can be rotated with the first shaft 8 and slid along the first shaft 8.

In this embodiment, the circular perforating blade 10 is composed of a circular blade body 10a and a plurality of double edges 10b attached to a circumference of the circular blade body 10a at even intervals. The circular blade body 10a is provided with a circular opening at its center and the circular opening has a diameter corresponding to a diameter of the second shaft 9. The circular perforating blade 10 is fixed to auxiliary members 12a and 12b (having openings whose diameters correspond to the diameter of the second shaft 9) while being nipped between the auxiliary members 12a and 12b.

Furthermore, although not shown in the drawings, each of the auxiliary members 12a and 12b is provided with a thread groove at a circumference thereof and the thread groove extend radially through the auxiliary member 12a, 12b. A setscrew is engaged with the thread groove. Thus the circular perforating blade 10 together with the auxiliary members 12a, 12b is fitted on the second shaft 9 and fixed at a desired position on the second shaft 9 by screwing the setscrew.

Also, although not shown in the drawings, a guide groove is formed on the first shaft 8 and extended along the first shaft 8, and the receiving roller 11 is provided with a radial through hole thereon. Further, a guide rod is inserted through and fixed to the through hole in a manner such that the guide rod enters into the guide groove. Thereby, the receiving roller 11 can slide along the guide groove in an axial direction of the first shaft 8 and rotate together with the first shaft 8.

As is clear from FIG. 4, a circular groove 13 is formed on the receiving roller 11 to be opposed to the plural double edges 10b of the associated circular perforating blade 10. A width of the circular groove 13 is larger than a thickness of each double edges 10b. The plural double edges 10b of the circular perforating blade 10 enter the associated circular groove 13 of the receiving roller 11 in such a manner that a tip of each double edges 10b is spaced a certain distance from a bottom of the circular groove 13.

When the circular perforating blade 10 is slid on the second shaft 9, correspondingly, the receiving roller 11 is slid on the first shaft 8, whereby a position of the corresponding receiving roller 11 is set automatically by setting a position of the circular perforating blade 10. Although the receiving roller 11 can be slid along the first shaft 8 in this embodiment, alternatively, like the circular perforating blade 10, the receiving roller 11 may be fixed at a desired position on the first shaft 8 by a setscrew.

At initial setting of the perforating unit 6, the paired circular perforating blade 10 and receiving roller 11 are arranged on the first and second shaft 8, 9 and set at a folding position of the second fold pattern in such a manner that the circular perforating blade 10 is opposed to a side of the sheet P2 to be valley folded while the receiving roller 11 is opposed to a side of the sheet P2 to be mountain folded.

Furthermore, in this embodiment, a plurality of first feed rollers 14a are mounted on the first shaft 8 so as to be rotated with the first shaft 8, and a plurality of second feed rollers 14b which correspond to the first feed roller 14a, respectively are mounted on the second shaft 9 so as to be rotated with the second shaft 9. The paired first and second feed rollers 14a, 14b contact with each other to constitute a feed roller pair.

According to the sheet folding machine of the present invention, the sheet P2 discharged from the first sheet folding unit 3 causes the bending fracture while being conveyed through a gap between the circular perforating blade 10 and receiving roller 11 by the feed roller pairs 14a, 14b of the perforating unit 6, whereby a line of perforations k according to the second fold pattern (a fold f2) is formed on the sheet P2 at a right angle to the folds f1 of the sheet P2.

As is clear from FIG. 4B, edges 22 of each perforation 21 of the line of perforations k formed by the bending fracture stand from a side of the sheet P2 in a direction of pushing of the double edges 10b of the circular perforating blade 10.

The standing edges 22 of each perforation 21 define a direction of folding of the sheet P2. That is to say, the side of the sheet P2 on which the standing edges 22 are positioned is smoothly mountain folded, but difficult to be valley folded because the standing edges 22 function as stoppers.

Furthermore, the line of perforations k corresponds to the second fold pattern to be formed by the second sheet folding unit 5. Thus the line of perforations k is formed at a position corresponding to the fold f2 of the second fold pattern in such a manner that the standing edges 22 of each perforation 21 are positioned on a side of the sheet P2 to be mountain folded while the standing edges 22 are not on a side of the sheet P2 to be valley folded.

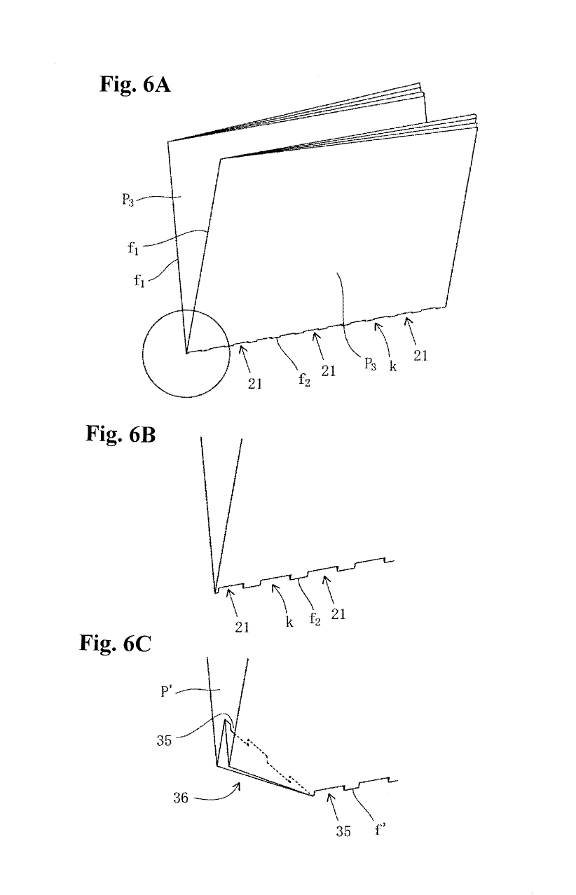

Thereafter, in the second sheet folding unit 5, the sheet P2 is folded along the line of perforations k in the second fold pattern so that a signature P3 is produced (FIG. 6A). According to the present invention, as shown in FIG. 6B, the signature P3 is surely prevented the sunk corner from arising because the side of the sheet P2 to be mountain folded is surely mountain folded while the side of the sheet P2 to be valley folded is surely valley folded.

Although some preferred embodiments of the present invention has been explained, the present invention is not limited to the above-mentioned embodiments. For example, although the first and second sheet folding units 3, 5 are buckle-type sheet folding units in the above-mentioned embodiments, knife-type sheet folding units may be replaced with the buckle-type sheet folding units. Also, although, in the above-mentioned embodiments, the feed roller pairs 14a, 14b are arranged on the first and second shafts 8, 9 as well as the paired circular perforating blade 10 and receiving roller 11 so that the sheet P2 is conveyed through the gap between the circular perforating blade 10 and receiving roller 11 by the feed roller pairs 14a, 14b, one or more appropriate well-known units for conveying the sheet P2 arranged upstream and/or downstream of the first and second shafts 8, 9 may be replaced with the feed roller pairs 14a, 14b.

### DESCRIPTION OF REFERENCE NUMERALS

1 Sheet feed unit
2 First conveying unit
3 First sheet folding unit
4 Second conveying unit
5 Second sheet folding unit
6 Perforating unit
7 Frame
8 First shaft
9 Second shaft
10 Circular perforating blade
10a Circular blade body
10b Double edges
11 Receiving roller
12a, 12b Auxiliary member
13 Circular groove
14a First feed roller
14b Second feed roller
15 Motor
16, 17 Drive roller
18, 19 Pulley
20 Drive belt
21 Perforation
22 Edge
30 Upper shaft
31 Lower shaft
32, 32′ Perforating blade
33 Receiving blade
34 Receiving roller
35 Edge of perforation
36 Sunk corner
f1 Fold (first fold pattern)
f2 Fold (second fold pattern)
k Line of perforations
P1 Sheet
P2 Folded sheet
P3 Signature
P′ Folded sheet

1. A method of forming a signature including steps of
(1) folding a sheet at a right angle to a travelling direction of the sheet in a predetermined first fold pattern while conveying the sheet in a first direction;
(2) forming one or more lines of perforations according to a predetermined second fold pattern on the folded sheet at a right angle to the fold(s) of the folded sheet; and
(3) further folding the folded sheet along the one or more lines of perforations to form a signature while conveying the folded sheet in a second direction perpendicular to the first direction, characterized in that
the formation of the one or more lines of perforations in the step (2) is performed by bending and fracturing the folded sheet at a right angle to the fold(s) of the folded sheet.

2. The method of forming a signature according to claim 1, wherein the bending fracture is caused by passing the folded sheet through a gap between at least one pair of a circular perforating blade and a receiving roller while conveying the folded sheet in the second direction, the paired circular perforating blade and receiving roller being arranged opposite to each other with a gap therebetween and rotating around an axis parallel with the first direction, respectively, wherein
the at least one pair of circular perforating blade and receiving roller is arranged in the first direction according to the second fold pattern, wherein
a plurality of double edges are attached to a circumference of the circular perforating blade at even intervals, and
a circular groove is formed on the receiving roller and opposed to the plural double edges of the associated circular perforating blade, a width of the circular groove being larger than a thickness of each double edges, wherein
the plural double edges of the circular perforating blade enter the associated circular groove of the receiving roller in such a manner that a tip of each double edges is spaced a certain distance from a bottom of the circular groove.

3. A sheet folding machine having a first folding unit;
a second folding unit arranged downstream of and at a right angle to the first folding unit; and
a perforating unit arranged between the first and second folding units, wherein
while a sheet is conveyed through the first folding unit, the perforating unit and the second folding unit, the sheet is folded at a right angle to the travelling direction thereof in a predetermined first fold pattern by the first folding unit, one or more lines of perforations are formed on the folded sheet by the perforating unit, the one or more lines of perforations being extended at a right angle to the fold(s) of the folded sheet according to a predetermined second fold pattern, and the folded sheet is further folded along the one or more lines of perforations by the second folding unit, characterized in that
the perforating unit comprises:
first and second shafts;
a motor for rotating the first shaft; and
a drive mechanism arranged between the first and second shafts to rotate the second shaft synchronously with the first shaft, wherein
one or more pairs of circular perforating blades and receiving rollers are mounted on the first and second shaft in such a manner that the paired circular perforating blade and receiving rollers are arranged opposite to each other, wherein
the circular perforating blade is provided with a plurality of double edges on a circumference thereof, the plural double edges being equally spaced, and the receiving roller is provided with a circular groove opposed to the plural double edges of the associated circular perforating blade, a width of the circular groove being larger than a thickness of each double edges, wherein
the plural double edges of the circular perforating blade enter the associated circular groove of the receiving roller in such a manner that a tip of each double edges is spaced a certain distance from a bottom of the circular groove, wherein
the one or more lines of perforations are formed by bending fracture of the folded sheet, the bending fracture being caused by the folded sheet folded by the first folding unit being conveyed through a gap between the pair of circular perforating blade and receiving roller.

4. The sheet folding machine according to claim 3, wherein the circular groove of the receiving roller has a rectangular cross-section.

5. The sheet folding machine according to claim 4, wherein a plurality of first feed rollers are mounted on the first shaft so as to be rotated with the first shaft, and a plurality of second feed rollers which correspond to the first rollers, respectively are mounted on the second shaft so as to be rotated with the second shaft, and the paired first and second rollers contact with each other to constitute a feed roller pair.
